(19) United States
(12) Patent Application Publication
(10) Pub. No.: US 2010/0218121 A1
(43) Pub. Date: Aug. 26, 2010

(54) VIRTUAL SPACE PROVISION SYSTEM, VIRTUAL SPACE PROVISION SERVER, VIRTUAL SPACE PROVISION METHOD, AND VIRTUAL SPACE PROVISION PROGRAM

(76) Inventors: Hirotada Sato, Tokyo (JP); Shuji Watanabe, Tokyo (JP); Tensei Ueda, Tokyo (JP)

Correspondence Address: ARENT FOX LLP, 1050 CONNECTICUT AVENUE, N.W., SUITE 400, WASHINGTON, DC, 20036, US

(21) Appl. No.: 12/675,715

(22) PCT Filed: Jul. 31, 2008
(86) PCT No.: PCT/JP2008/063746

§ 371 Date: Feb. 26, 2010

(30) Foreign Application Priority Data
Aug. 30, 2007 (JP) 2007-224629

(51) Int. Cl. G06F 13/00; G06F 15/00

(52) U.S. Cl. 715/757

(57) ABSTRACT

A virtual space is provided in which users interested in any one of various Web pages can meet each other in real time through the Web page that interests them.

When any one Web page is viewed on user terminals 310 to 330, the Web address information of the Web page is acquired and sent to a virtual space provision server 100. Then, a virtual space is produced based on the virtual space information according to the Web address information from the virtual space provision server 100. Furthermore, for example, any change in an avatar image and item image within the virtual space on one of the user terminals 310 to 330 is reflected on the virtual space of another one of the user terminals 310 to 330. This allows those users viewing the same Web page to share the virtual space of the same contents with one another.

### TECHNICAL FIELD

The present invention relates to a virtual space provision system, a virtual space provision server, a virtual space provision method, and a virtual space provision program for a plurality of users to share a virtual space with one another via a network.

### BACKGROUND ART

Recently, there are available online games and communication games which make use of a virtual space displayed on the screen of personal computers via a network.

As used herein, the term “online game” refers to a game in which an indefinite number of people participate via a network, for example, to compete against one another through the network. That is, the online game itself is to operate on the operating system (OS) of the personal computer of each user, which is connected to a game server via the Internet. This allows the online game to develop a virtual game space that each user can share on the screen of the personal computer of each user. The online game enables the users to exchange data or information in the game space, for example, to advance a quest (or to advance a mini game by meeting one's own quota).

On the other hand, for example, unlike the game in which the garners compete against one another, the communication game is a game in which an indefinite number of people take part via a network to enjoy exchanging messages within the virtual space. That is, with the personal computer of each user connected to a predetermined virtual space server via the Internet, the communication game allows a virtual space that each user can share to be developed on the screen of the personal computer of each user.

The virtual space may be any city, any town, or any island. For example, suppose that the virtual space of certain city has been developed. Then, the game allows each user to have his/her avatar image (a graphical image representing the user) displayed in the city and manipulate the mouse or the like to thereby change the position or the line of sight of the avatar image. The user can also manipulate the mouse or the like to change the position of the avatar image to thereby walk around the city for fun.

Furthermore, for example, one avatar image may be changed in position by manipulating the mouse or the like to get closer to another avatar image. In this case, the game can display the face image, the speech, or the profile in text characters of each user on each avatar image, so that these pieces of information can be exchanged for fun by sharing the virtual space.

Use was made of such a virtual space in a communication management method as disclosed in Patent Document 1. The method was suggested to properly manage the way users actually communicated with one another when they met in the virtual space formed in a network.

This method allows an event detection section to detect the occurrence of a communicative event between a first user and a second user. When the event detection section has detected the occurrence of an event, a unit time measurement section starts measuring time, even when time is already being measured, in order to determine whether the predetermined unit time has elapsed after the occurrence of the event has been detected. If it is determined from the measurement of time that unit time has elapsed, the end of the measurement of time is delivered. Then, the method allows a communication period determination section to determine, as one communication period, a period from the detection of the occurrence of the event to the delivery of the end signal, during which time was not being measured.

### [Patent Document 1] Japanese Patent Application Laid-Open No. 2004-272579

### DISCLOSURE OF THE INVENTION

### Problems to be Solved by the Invention

In Patent Document 1 described above, the period from the detection of the occurrence of an event to the delivery of an end signal, during which time is not being measured, is to be determined as one communication period. This allows for properly managing actual communications between users.

However, making use of such a virtual space allows only those users, who have logged in a given Web server for providing the predetermined contents, to utilize the communication service with one another. Thus, the communication service is limited only to a group of users who are interested in the predetermined contents. In other words, it is not possible to provide such a virtual space that enables those users who are interested in any one of various Web pages to meet one another in real time through the Web page that interests them.

As can be seen from the above discussion, it has been long desired to build a system that can provide a virtual space in which those users interested in any one of various Web pages can meet one another in real time through the Web page that interests them.

The present invention was developed in view of these problems. It is therefore an object of the present invention to provide a virtual space provision system, a virtual space provision server, and a virtual space provision method, and a virtual space provision program which can offer a virtual space for those users interested in any one of various Web pages to be able to meet one another in real time through the Web page that interests them.

### Means for Solving the Problems

A virtual space provision system of the present invention, comprises a plurality of user terminals and a virtual space provision server connected to each other via a network. The user terminal comprises: Web server access means for connecting to a Web server via the network; Web address information acquisition means for acquiring Web address information from the accessed Web server; Web page viewing means for acquiring Web page information from the acquired Web address for displaying on display means; transmission means for sending the Web address information and virtual space user information stored in storage means of the terminal to the virtual space provision server; virtual space information reception means for receiving virtual space information based on the Web address information from the virtual space provision server; and virtual space display control means for allowing a virtual space image based on the Web address information and an avatar image of a user accessing the Web address to be created in accordance with the received virtual space information and displayed on the display means. The virtual space provision server comprises: Web address information reception means for receiving Web address information acquired by a first user terminal and a first piece of the virtual space user information from the first user terminal; virtual space information creation means for creating virtual space information based on the received Web address information, the first piece of the virtual space user information, and a second piece of the virtual space user information from a second user terminal accessing the Web address; and virtual space information transmission means for sending the created virtual space information to a group of the first user terminal and the second user terminal.

Further, the virtual space provision server can have program provision means for providing a virtual space creation program to display the virtual space in response to a request from the user terminal. The virtual space information creation means transmits virtual space creation data for allowing the virtual space creation program to display a virtual space.

Further, the plurality of user terminals can have first data transmission means for sending avatar change data involved in a movement of an avatar image selected from among various types of elements contained in the virtual space creation program to the virtual space provision server, avatar change data detection means for detecting avatar change data involved in a movement of an avatar image on another one of the user terminals from virtual space creation data provided by the virtual space provision server and tied to a change on the another one of the user terminals, and first virtual space edit means for performing edit processing to provide the same contents as those of the virtual space on the another one of the user terminals when the avatar change data is detected. The virtual space provision server has avatar change data detection means for detecting the avatar change data sent from any one of the user terminals, and avatar change data transmission means for sending the virtual space creation data indicative of the avatar change data to another one of the user terminals when the avatar change data detection means detects the avatar change data.

Further, the plurality of user terminals can have second data transmission means for sending item change data involved in selecting or deleting a predetermined item image selected from among various types of elements contained in the virtual space creation program to the virtual space provision server, item change data detection means for detecting item change data involved in selecting or deleting an item image on another one of the user terminals from virtual space creation data provided by the virtual space provision server and tied to a change on the another one of the user terminals, and second virtual space edit means for performing edit processing to provide the same contents as those of the virtual space on the another one of the user terminals when the item change data detection means detects the item change data. The virtual space provision server has item change data detection means for detecting the item change data sent from any one of the user terminals, and item change data transmission means for sending virtual space creation data indicative of the item change data to another one of the user terminals when the item change data detection means detects the item change data.

Further, the virtual space provision server can have virtual space allocation means for allocating a virtual space in accordance with the Web address information detected by the Web address information detection means. When the same Web address information is sent from each of the user terminals, the virtual space allocation means makes an allocation to each of the user terminals so that a virtual space of the same contents is produced thereon, whereas when different pieces of the Web address information are sent from each of the user terminals, the virtual space allocation means makes an allocation to each of the user terminals so that a virtual space is produced thereon according to respective pieces of the Web address information.

Further, the virtual space provision server can have virtual space management means for at least saving a virtual space caused by the virtual space creation data being transmitted, and for deleting the saved virtual space when at least the number of the avatar images in the saved virtual space becomes zero.

Further, the plurality of user terminals can have hash value creation means for creating a fixed-length hash value based on the acquired Web address information. The virtual space provision server creates virtual space creation data for creating a virtual space according to the hash value and transmits the data to the user terminal having sent the hash value.

Further, the Web server access means can have Web address information of the virtual space provision server and includes a virtual space icon, either separately or added on to some browser.

A virtual space provision server of the present invention comprises: Web address information reception means for receiving Web address information acquired by a first user terminal and a first piece of the virtual space user information from the first user terminal; virtual space information creation means for creating virtual space information based on the received Web address information, the first piece of the virtual space user information, and a second piece of the virtual space user information from a second user terminal accessing the Web address; and virtual space information transmission means for sending the created virtual space information to a group of the first user terminal and the second user terminal.

Further, the virtual space provision server can have program provision means for providing a virtual space creation program to display the virtual space in response to a request from any of the user terminals. The virtual space information creation means transmits virtual space creation data for displaying the virtual space by virtue of the virtual space creation program.

Further, the virtual space provision server can have: avatar change data detection means for detecting the avatar change data sent from any one of the user terminals; and avatar change data transmission means for sending virtual space creation data indicative of the avatar change data to another one of the user terminals when the avatar change data detection means detects the avatar change data.

Further, the virtual space provision server can have: item change data detection means for detecting the item change data sent from any one of the user terminals; and item change data transmission means for sending virtual space creation data indicative of the item change data to another one of the user terminals when the item change data detection means detects the item change data.

Further, the virtual space provision server can have virtual space allocation means for allocating the virtual space in accordance with the Web address information detected by the Web address information detection means. When the same Web address information is sent from each of the user terminals, the virtual space allocation means makes an allocation to each of the user terminals so that a virtual space of the same contents is produced thereon. On the other hand, when different pieces of the Web address information are sent from each of the user terminals, the virtual space allocation means makes an allocation to each of the user terminals so that a virtual space is produced thereon according to respective pieces of the Web address information.

Further, the virtual space provision server can have virtual space management means for at least saving the virtual space caused by the virtual space creation data being transmitted, and for deleting the saved virtual space when at least the number of the avatar images in the virtual space becomes zero.

Further, the virtual space provision server can be formed such that virtual space creation data for creating a virtual space according to a fixed-length hash value based on the Web address information acquired on the user terminal is created and then sent to the user terminal having transmitted the hash value.

A virtual space provision method of the present invention can be formed such that when a plurality of user terminals share a virtual space via a network and a virtual space provision server connected to the network displays the virtual space on the plurality of the user terminals, it allows the plurality of user terminals to follow the steps of: connecting to a Web server via the network; acquiring Web address information of the accessed Web server; acquiring Web page information from the acquired Web address and displaying the same on display means; sending the Web address information and virtual space user information stored in storage means of the terminal to the virtual space provision server; receiving virtual space information based on the Web address information from the virtual space provision server; and creating a virtual space image based on the Web address information and an avatar image of a user accessing the Web address in accordance with the received virtual space information and displaying the same on the display means. The method also allows the virtual space provision server to follow the steps of: receiving Web address information acquired by a first user terminal and a first piece of the virtual space user information from the first user terminal; creating virtual space information based on the received Web address information, the first piece of the virtual space user information, and a second piece of the virtual space user information from a second user terminal accessing the Web address; and sending the created virtual space information to a group of the first user terminal and the second user terminal.

Further, the virtual space provision server can follow a step of providing a virtual space creation program for displaying the virtual space in response to a request from the user terminal, and after the virtual space creation program is provided, transmits virtual space creation data for displaying the virtual space by virtue of the virtual space creation program.

Further, the virtual space provision method can allow the plurality of user terminals to follow the steps of: sending avatar change data involved in a movement of an avatar image selected from among various types of elements contained in the virtual space creation program to the virtual space provision server; detecting avatar change data involved in a movement of an avatar image on another one of the user terminals, from virtual space creation data tied to a change on the another one of the user terminals provided by the virtual space provision server; and performing edit processing to provide the same contents as those of the virtual space on the another one of the user terminals when the avatar change data is detected. The method also allows the virtual space provision server to follow the steps of: detecting the avatar change data sent from anyone of the user terminals; and sending the virtual space creation data indicative of the avatar change data to another one of the user terminals when the avatar change data is detected.

Further, the virtual space provision method can allow the plurality of user terminals to follow the steps of: sending item change data involved in selecting or deleting a predetermined item image selected from among various types of elements contained in the virtual space creation program to the virtual space provision server; detecting item change data involved in selecting or deleting an item image on another one of the user terminals from virtual space creation data provided by the virtual space provision server and tied to a change on the another one of the user terminals; and performing edit processing to provide the same contents as those of the virtual space on the another one of the user terminals when the item change data is detected. The method also allows the virtual space provision server to follow the steps of: detecting the item change data sent from any one of the user terminals; and sending virtual space creation data indicative of the item change data to another one of the user terminals when the item change data is detected.

Further, the virtual space provision method can allow the virtual space provision server to follow the step of allocating the virtual space in accordance with the Web address information detected by the Web address information detection means. When the same Web address information is sent from each of the user terminals, an allocation is made to each of the user terminals so that a virtual space of the same contents is produced thereon, whereas when different pieces of the Web address information are sent from the respective user terminals, an allocation is made to each of the user terminals so that a virtual space is produced thereon according to respective pieces of the Web address information.

Further, the virtual space provision method can allow the virtual space provision server to follow the step of at least saving a virtual space caused by the virtual space creation data being transmitted, and deleting the saved virtual space when at least the number of the avatar images in the virtual space becomes zero.

Further, the virtual space provision method can allow the plurality of user terminals to follow the step of creating a fixed-length hash value based on the acquired Web address information. The virtual space provision server creates virtual space creation data for creating a virtual space according to the hash value and transmits the data to the user terminal having sent the hash value.

A virtual space provision program of the present invention is implemented by a computer. When a plurality of user terminals share a virtual space via a network and a virtual space provision server connected to the network displays the virtual space on the plurality of the user terminals, the program allows the plurality of user terminals to follow the steps of: connecting to a Web server via the network; acquiring Web address information of the accessed Web server; acquiring Web page information from the acquired Web address and displays the same on display means; sending the Web address information and virtual space user information stored in storage means of the terminal to the virtual space provision server; receiving virtual space information based on the Web address information from the virtual space provision server; and creating a virtual space image based on the Web address information and an avatar image of a user accessing the Web address in accordance with the received virtual space information and display the same on the display means The program also allows the virtual space provision server to follow the steps of: receiving Web address information acquired by a first user terminal and a first piece of the virtual space user information from the first user terminal; creating virtual space information based on the received Web address information, the first piece of the virtual space user information, and a second piece of the virtual space user information from a seconduser terminal accessing the Web address; and sending the created virtual space information to a group of the first user terminal and the second user terminal.

Further, the virtual space provision program can allow the virtual space provision server to follow a step of providing a virtual space creation program to display the virtual space in response to a request from the user terminal. After the virtual space creation program is provided, the virtual space provision server transmits virtual space creation data for displaying the virtual space by virtue of the virtual space creation program.

Further, the virtual space provision program can allow the plurality of user terminals to follow the steps of: sending avatar change data involved in a movement of an avatar image selected from among various types of elements contained in the virtual space creation program to the virtual space provision server; detecting avatar change data involved in a movement of an avatar image on another one of the user terminals from virtual space creation data provided by the virtual space provision server and tied to a change on the another one of the user terminals; and performing edit processing to provide the same contents as those of the virtual space on the another one of the user terminals when the avatar change data is detected. The program also allows the virtual space provision server to follow the steps of: detecting the avatar change data sent from any one of the user terminals; and sending the virtual space creation data indicative of the avatar change data to another one of the user terminals when the avatar change data is detected.

Further, the virtual space provision program can allow the plurality of user terminals to follow the steps of: sending item change data involved in selecting or deleting a predetermined item image selected from among various types of elements contained in the virtual space creation program, to the virtual space provision server; detecting item change data involved in selecting or deleting an item image on another one of the user terminals from virtual space creation data provided by the virtual space provision server and tied to a change on the another one of the user terminals; and performing edit processing to provide the same contents as those of the virtual space on the another one of the user terminals when the item change data is detected. The program also allows the virtual space provision server to follow the steps of: detecting the item change data sent from any one of the user terminals; and sending virtual space creation data indicative of the item change data to another one of the user terminals when the item change data is detected.

Further, the virtual space provision program can allow the virtual space provision server to follow the step of allocating the virtual space in accordance with the Web address information detected by the Web address information detection means. When the same Web address information is sent from each of the user terminals, an allocation is made to each of the user terminals so that a virtual space of the same contents is produced thereon, whereas when different pieces of the Web address information are sent from the respective user terminals, an allocation is made to each of the user terminals so that a virtual space is produced thereon according to respective pieces of the Web address information.

Further, the virtual space provision program can allow the virtual space provision server to follow the step of at least saving a virtual space caused by the virtual space creation data being transmitted, and deleting the saved virtual space when at least the number of the avatar images in the virtual space becomes zero.

Further, the virtual space provision program can allow the plurality of user terminals to follow the step of creating a fixed-length hash value based on the acquired Web address information. The virtual space provision server creates virtual space creation data for creating a virtual space according to the hash value and transmits the data to the user terminal having sent the hash value.

According to the virtual space provision system, the virtual space provision server and the virtual space provision method as well as the virtual space provision program of the present invention, a plurality of user terminals share a virtual space via a network, and the virtual space provision server connected to the network displays the virtual space on the user terminals. At this time, when any one of the user terminals is connecting to the Web server via a network, the Web address information of the accessed Web server is acquired, so that the Web page information is acquired from the acquired Web address and displayed on display means. Furthermore, the Web address information is sent to the virtual space provision server along with virtual space user information stored in the storage means of the terminal. When virtual space information based on the Web address information has been received from the virtual space provision server, a virtual space image based on the Web address information and an avatar image of the user accessing the Web address are produced in accordance with the received virtual space information and displayed on the display means.

On the other hand, the virtual space provision server receives the Web address information acquired by a first user terminal and a first piece of the virtual space user information from the first user terminal. Then, this is followed by creating virtual space information based on the received Web address information, the first piece of the virtual space user information, and a second piece of the virtual space user information from a second user terminal accessing the Web address. The resulting virtual space information is sent to a group of the first user terminal and the second user terminal.

Thus, the user terminal acquires the Web address information of a Web page that is being viewed thereon, and sends it to the virtual space provision server. The terminal then creates a virtual space in accordance with virtual space information according to the Web address information from the virtual space provision server. Furthermore, for example, any change in avatar image or item image within the virtual space on any one of the user terminals is reflected on the virtual space of another user terminal. This allows those users viewing the same Web page to share the virtual space of the same contents with one another.

### EFFECTS OF THE INVENTION

According to the virtual space provision system, the virtual space provision server, the virtual space provision method, and the virtual space provision program of the present invention, a user terminal acquires the Web address information of the Web page that is being viewed thereon, and sends it to the virtual space provision server. The user terminal produces a virtual space based on virtual space information according to the Web address information from the virtual space provision server. Furthermore, for example, any change in an avatar image or item image within the virtual space of any one user terminal is reflected on the virtual space of another user terminal. This allows those users viewing the same Web page to share the virtual space of the same contents with one another. It is thus possible to provide a virtual space in which those users who are interested in any one of various Web pages can meet one another in real time through the Web page that interests them.

### BRIEF DESCRIPTION OF THE DRAWINGS

FIG. 1 is a view illustrating a virtual space provision system according to one embodiment of the present invention;

FIG. 2 is an explanatory view illustrating the virtual space provision server of FIG. 1 in more detail;

FIG. 3 is an explanatory view illustrating the user terminal of FIG. 1 in more detail;

FIG. 4 is an explanatory flowchart showing a virtual space creation routine in the virtual space provision system of FIG. 1;

FIG. 5 is an explanatory flowchart showing the start-up processing of the virtual space creation program of FIG. 4;

FIG. 6 is an explanatory flowchart showinghowto share avirtual space in the virtual space provision system of FIG. 1;

FIG. 7 is an explanatory flowchart showinghow to share a virtual space in the virtual space provision system of FIG. 1;

FIG. 8 is an explanatory view showing how to share a virtual space in the virtual space provision system of FIG. 1; and

FIG. 9 is an explanatory view showing how to share a virtual space in the virtual space provision system of FIG. 1.

### BEST MODE FOR CARRYING OUT THE INVENTION

In the present embodiment, a user terminal acquires the Web address information of the Web page that is being viewed thereon, and sends it to a virtual space provision server. The user terminal produces a virtual space based on virtual space information according to the Web address information from the virtual space provision server. Furthermore, for example, any change in an avatar image or item image within the virtual space of any one user terminal is reflected on the virtual space of another user terminal. This allows those users viewing the same Web page to share the virtual space of the same contents with one another.

In this case, a plurality of user terminals connected to a network can install a virtual space creation program therein, for example, from a virtual space provision server, thereby displaying a virtual space on the screen of the user terminals. Here, the virtual space creation program may contain at least: Web server access means for connecting to a Web server via a network; Web address information acquisition means for acquiring Web address information of an accessed Web server; Web page viewing means for acquiring Web page information from the acquired Web address and displaying the information on display means; transmission means for sending the Web address information and virtual space user information stored in storage means of the terminal to the virtual space provision server; virtual space information reception means for receiving virtual space information based on the Web address information from the virtual space provision server; and virtual space display control means for creating a virtual space image based on the Web address information and an avatar image of a user accessing the Web address in accordance with the received virtual space information and displaying the same on the display means.

Note that as means for accessing the virtual space provision server via a network, it is possible to employ, for example, a combination of a virtual space icon having the Web address information of the virtual space provision server with means for accessing the virtual space provision server by detecting the virtual space icon being clicked (or selected).

Alternatively, it is also possible to employ a combination of a predetermined tool bar incorporating the virtual space icon with means for accessing the virtual space provision server by detecting the virtual space icon being clicked (or selected).

On the other hand, the virtual space icon or the predetermined tool bar having incorporated the virtual space icon may be separately displayed on the screen of a user terminal, incorporated into a dedicated browser, or added on to an existing browser.

Then, for example, the virtual space icon may be clicked when a browser is used to view some Web page. At this time, the Web address information of the Web page is detected, and based on the virtual space creation data obtained in response to the detected Web address information and provided by the virtual space provision server, various types of elements contained in the virtual space creation program that has already been installed are used to produce a virtual space. In this case, for example, the Web address information may be a fixed-length hash value.

On the other hand, the virtual space provision server manages user information that is used for access from a plurality of user terminals and for example, contains at least a user ID and a password. Any user terminal whose user information has been registered is provided with a virtual space creation program for realizing a virtual space. When Web address information sent from a user terminal has been detected, virtual space creation data for creating a virtual space according to the detected Web address information is produced and sent to the user terminal that has transmitted the Web address information. In this case, as described above, for example, the Web address information may be a fixed-length hash value.

As described above, when a Web page is being viewed on a user terminal, for example, a virtual space icon for accessing the virtual space provision server may be clicked. At this time, for example, a hash value according to the Web address information of the Web page being viewed is sent to the virtual space provision server. Then, for example, based on virtual space creation data according to the hash value from the virtual space provision server, a virtual space is produced. This allows those users who are viewing the same Web page to share the virtual space of the same contents with one another, thus providing such a virtual space that allows those users who are interested in any one of various Web pages to meet one another in real time through the Web page that interests them.

### Example

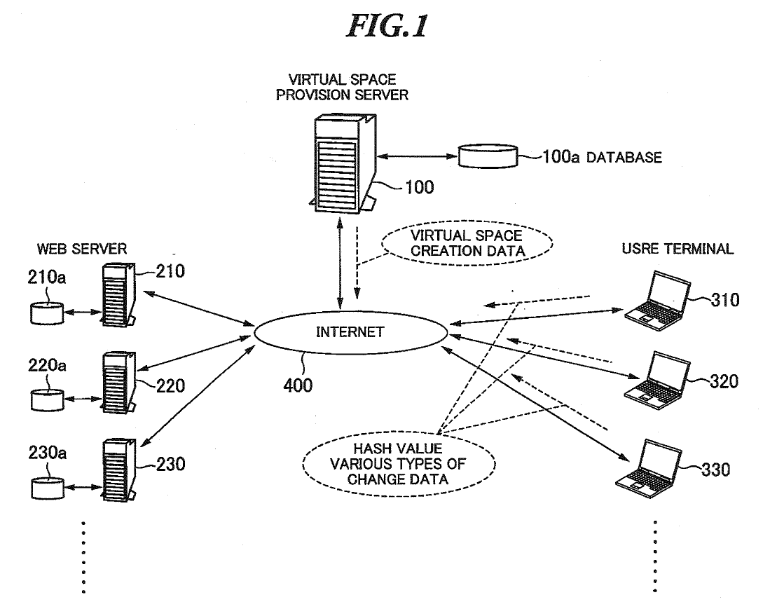

A more detailed description will now be made to examples of the present invention. FIG. 1 is a view illustrating a virtual space provision system according to one embodiment of the present invention.

As illustrated in the figure, a virtual space provision system includes a virtual space provision server 100, Web servers 210 to 230, and user terminals 310 to 330, all of which are connected via the Internet 400 serving as a communication line. Note that dedicated lines or Wide Area Networks (WAN) can also be used as the communication line.

The virtual space provision server 100 has a database 100a which has registered at least a virtual space creation program required to create a virtual space for communication games. The server 100 provides a virtual space in which those users who are interested in any one of various Web pages can meet one another in real time through the Web page that interests them.

At this time, at least virtual space creation data according to a hash value obtained from Web address information (to be described later) from the user terminals 310 to 330 is given to those of the user terminals 310 to 330 which have transmitted the hash value. Alternatively, virtual space creation data according to various types of change data (to be described later) from the user terminals 310 to 330 is provided to each of the user terminals 310 to 330. This allows each of the user terminals 310 to 330 to share the same virtual space, as will be discussed in more detail later.

The Web servers 210 to 230 have databases 210a to 230a, for example, providing various Web pages such as search sites (Yahoo, Google or the like), homepages (sites provided by individuals or enterprises), or blogs (diary-like sites provided by individuals or enterprises).

The user terminals 310 to 330 log in the virtual space provision server 100 to acquire a user ID and a password as well as to download, for example, a virtual space creation program necessary for communication games, thereby allowing the virtual space to be displayed on a display section 318 (to be described later). The user terminals 310 to 330 can be cellular phones, PDAs, desktop personal computers, laptop computers, or game machines.

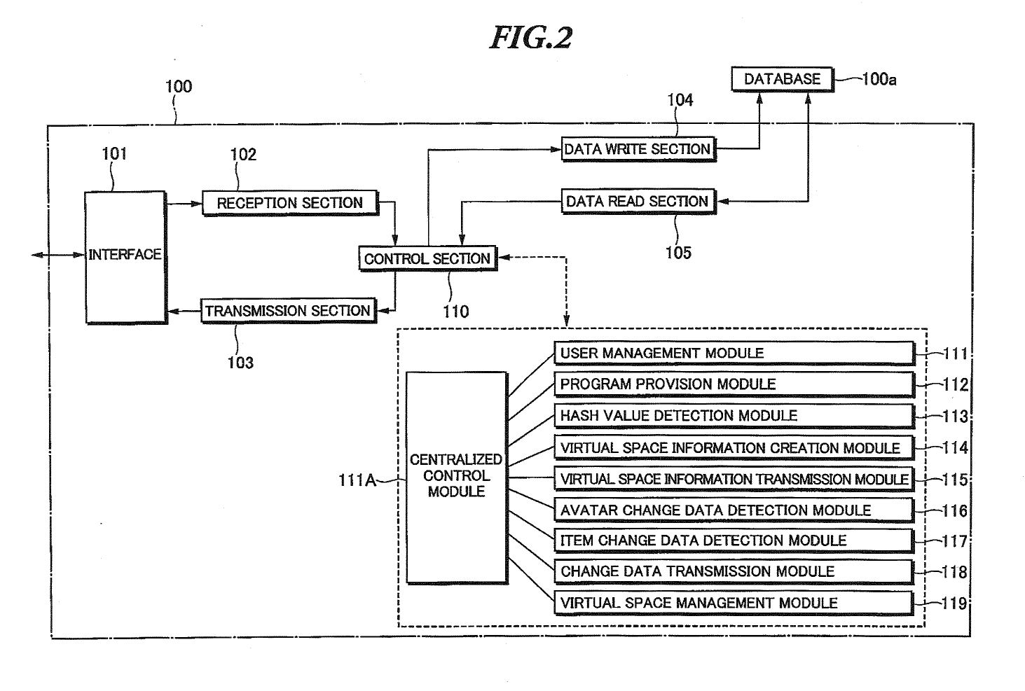

FIG. 2 is an explanatory view illustrating the virtual space provision server 100 in more detail. As illustrated in the figure, the virtual space provision server 100 includes an interface 101, a reception section 102, a transmission section 103, a data write section 104, a data read section 105, and a control section 110.

The interface 101 performs a data communication with the user terminals 310 to 330 via the Internet 400.

The reception section 102 receives data relating to access from the user terminals 310 to 330. Here, the data relating to access refers to data indicative of user IDs and passwords for log-in, avatar change data involved in a movement of avatar images (a graphical image representing the user) in a virtual space, item change data involved in setting up items such as houses or item setup cancellation, or the like. Note that these pieces of data are to be sent in real time to the virtual space provision server 100 by a virtual space creation program installed in the user terminals 310 to 330, as will be described later.

The transmission section 103 transmits at least the virtual space creation program provided by the virtual space provision server 100 for creating a virtual space to those of the user terminals 310 to 330 that have registered user information containing at least their user IDs and passwords.

The data write section 104 registers user information containing at least a user ID and password in the database 100a. Furthermore, upon setting up item images such as houses on any one of the user terminals 310 to 330, the data write section 104 registers with the database 100a the item setup data tied to the user ID and password as well as the data for creating a virtual space when the item image is set up.

The data read section 105 reads from the database 100a the virtual space creation program for creating a virtual space on the display section 318 (to be described later) of the user terminals 310 to 330. The virtual space is provided by the virtual space provision server 100 to those of the user terminals 310 to 330 that have registered their user information containing at least their user IDs and passwords.

Furthermore, when any one of the user terminals 310 to 330 whose item setup data has been registered with the database 100a has logged in again, the data read section 105 reads from the database 100a the item setup data tied to the user ID and password from the one of the user terminals 310 to 330 as well as the data for creating the virtual space when the item image is set up.

The control section 110 controls the operation of each section based on a predetermined control program relating to the provision of a communication virtual space stored in a ROM (not shown). Further, based on a predetermined control program, the control section 110 implements an user management module 111, a program provision module 112, a hash value detection module 113, a virtual space information creation module 114, a virtual space information transmission module 115, an avatar change data detection module 116, an item change data detection module 117, a change data transmission module 118, a virtual space management module 119, and a centralized control module 111A.

Here, the user management module 111, the program provision module 112, the hash value detection module 113, the virtual space information creation module 114, the virtual space information transmission module 115, the avatar change data detection module 116, the item change data detection module 117, the change data transmission module 118, the virtual space management module 119, and the centralized control module 111A execute the following processing.

The user management module 111 manages virtual space user information containing at least user IDs and passwords. The user management module 111 also manages the session from the log-in accompanied by the user ID and password being entered from any one of the user terminals to the log-out by which the use of the virtual space is stopped. This makes it possible to manage in real time the change-related data relating to a movement of an avatar image (a graphical image representing the user) or setup of an item image in a virtual space from the time any one of the user terminals has logged in.

The program provision module 112 provides a virtual space creation program to those of the user terminals 310 to 330 that have registered their user information containing at least their user IDs and passwords. The program allows a virtual space provided by the virtual space provision server 100 to be created on the display section 318 (to be described later) of the user terminals 310 to 330.

The hash value detection module 113 serving as Web address information reception means detects a hash value as Web address information sent from the user terminals 310 to 330. Here, the Web address information is the address information of a Web page that is acquired by clicking, for example, a virtual space icon when the Web page is being viewed using a browser on any one of the user terminals 310 to 330. Furthermore, the Web address information has been converted into a hash value which is created using a hash function for creating fixed-length data. Note that the Web address information reception means includes the user management module 111 mentioned above.

The virtual space information creation module 114 serving as virtual space information creation means creates virtual space information based on the hash value or the received Web address information, the virtual space user information of any one of the user terminals 310 to 330 having transmitted the hash value, and the virtual space user information of another one of the user terminals 310 to 330 accessing the Web address.

Here, upon creating the virtual space information, the virtual space information creation module 114 allocates a virtual space displayed on the user terminals 310 to 330 in accordance with the hash value detected by the hash value detection module 113. That is, in principle, if the hash values from the user terminals 310 to 330 are the same, then the virtual space of the same contents is produced on each of the user terminals 310 to 330.

However, an excessive number of users concentrated in one virtual space would cause an increase in avatar images (graphical images representing the users) in the virtual space on each of the user terminals 310 to 330. This increase would not only make complicated the management of the session by the user management module 111, but also delay the response from the virtual space provision server 100. This would possibly cause inconvenience such as delay in progression of communication games.

For this reason, the virtual space information creation module 114 allocates a virtual space so that, for example, 500 avatar images (graphical images representing users) can exist in one virtual space. This allocation is done when the hash values from the user terminals 310 to 330 are the same, i.e., when those pieces of the Web address information from the user terminals 310 to 330 are the same. Of course, the number of avatar images (graphical images representing users) that can exist in one virtual space is not limited to 500.

On the other hand, the user terminals 310 to 330 may provide different hash values, i.e., those pieces of the Web address information from the user terminals 310 to 330 may be different from each other. In this case, the virtual space information creation module 114 makes an allocation so that a virtual space is produced according to the hash value of the respective pieces of the Web address information.

Suppose that a hash values is in response to the Web address information provided when a game-related Web page is being viewed on the user terminals 310 to 330. In this case, such a virtual space allocation allows the users viewing the game-related Web page to share the same virtual space with one another. Further, when the hash value is in response to the Web address information, for example, provided when a travel-related Web page is being viewed, the predetermined browser allows the users viewing the travel-related Web page to share the same virtual space with one another.

That is, the users according to the Web address information of a Web page being viewed by them with a predetermined browser and displayed on the user terminals 310 to 330 are allowed to share the same virtual space with one another.

The virtual space information transmission module 115 serving as virtual space information transmission means sends the virtual space information created by the virtual space information creation module 114 to the user terminals 310 to 330 accessing the same Web address.

The avatar change data detection module 116 serving as avatar change data detection means detects avatar change data involved in a movement of avatar images (graphical images representing users) in the virtual space of the user terminals 310 to 330. That is, for example, the avatar change data is detected as data in response to a change in the position (coordinates) of an avatar image in the virtual space of the user terminals 310 to 330.

Furthermore, such avatar change data is to be sent in real time to the virtual space provision server 100 by the virtual space creation program installed in the user terminals 310 to 330. This makes a real-time detection possible while the session is managed by the aforementioned user management module 111.

The item change data detection module 117 serving as item change data detection means detects item change data relating to setting up items such as houses or item setup cancellation in the virtual space of the user terminals 310 to 330. That is, the item change data is sent in real time to the virtual space provision server 100 by the virtual space creation program installed in the user terminals 310 to 330. The data can thus be detected while the session is managed by the aforementioned user management module 111.

The change data transmission module 118 sends to another one of the user terminals 310 to 330 the virtual space creation data indicative of the aforementioned avatar change data or item change data detected by the avatar change data detection module 116 and/or the item change data detection module 117.

Thus, for example, with the user terminals 310 to 330 each sharing the same virtual space, virtual space creation data may be sent to the user terminals 320 and 330. Here, for example, the virtual space creation data may relate to a movement of an avatar image (a graphical images representing the user) changed on the user terminal 310, the setup of items such as houses, or item setup cancellation. This allows the same virtual space contents to be displayed on all the user terminals 310 to 330.

The virtual space management module 119 serving as virtual space management means requests the control section 110 to save in the database 100a at least a virtual space provided by the virtual space creation data being produced at the virtual space information transmission module 115. The module 119 also requests the control section 110 to delete the saved virtual space at the point in time at which the number of avatar images therein has become zero.

The centralized control module 111A collectively manages the processing at the user management module 111, the program provision module 112, the hash value detection module 113, the virtual space information creation module 114, the virtual space information transmission module 115, the avatar change data detection module 116, the item change data detection module 117, the change data transmission module 118, and the virtual space management module 119.

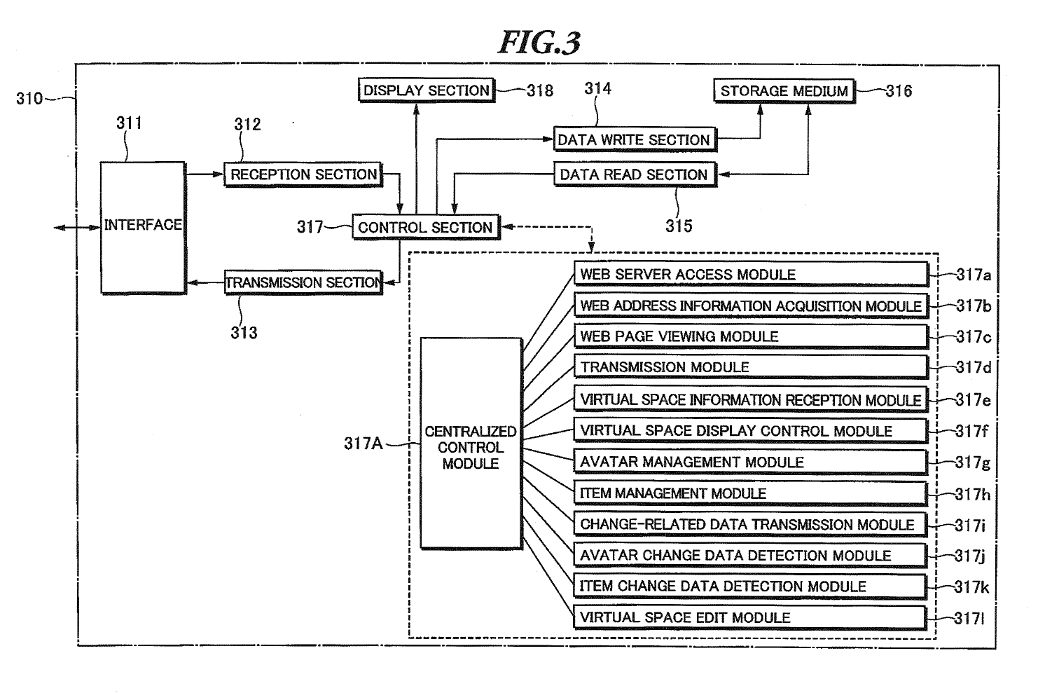

FIG. 3 is an explanatory view illustrating the user terminals 310 to 330 in more detail. Note that the user terminals 310 to 330 to be discussed below each have generally the same configuration, and will thus be represented by the user terminal 310 for an easy explanation.

As illustrated in the figure, the user terminal 310 includes an interface 311, a reception section 312, a transmission section 313, a data write section 314, a data read section 315, a storage medium 316, a control section 317, and the display section 318.

The interface 311 performs a data communication via the Internet 400 with the virtual space provision server 100 and the Web servers 210 to 230.

The reception section 312 receives data for displaying various Web pages, such as some searching sites, homepages, or blogs, which are obtained by accessing any one of the Web servers 210 to 230 using any one of the aforementioned browsers.

The reception section 312 also receives the virtual space creation program obtained by accessing the virtual space provision server 100. Furthermore, after the virtual space creation program is installed, the reception section 312 receives the virtual space creation data for creating a virtual space. The reception section 312 further receives another virtual space creation data indicative of change data such as avatar change data involved in a movement of an avatar image (a graphical image representing the user) changed in the virtual space of another one of the user terminals 320 and 330. The change data also includes item change data involved in setting up items such as houses or item setup cancellation.

The transmission section 313 transmits access information for accessing one of the Web servers 210 to 230 or for access to the virtual space provision server 100. The transmission section 313 also transmits user information containing at least the user ID and password necessary for logging into the virtual space provision server 100. Furthermore, the transmission section 313 also transmits change-related data such as avatar change data involved in a movement of an avatar image (a graphical image representing the user) changed in its own virtual space or item change data involved in setting up items such as houses or item setup cancellation.

The data write section 314 writes access logs for at least one of the Web servers 210 to 230 or access logs for the virtual space provision server 100, or a virtual space creation program downloaded from the virtual space provision server 100 onto the storage medium 316.

To install at least a virtual space creation program downloaded from the virtual space provision server 100, the data read section 315 reads out the virtual space creation program from the storage medium 316.

The storage medium 316 is supplied with data written by the data write section 314. The data includes at least access logs for one of the Web servers 210 to 230, access logs for the virtual space provision server 100, or the virtual space creation program downloaded from the virtual space provision server 100. Here, the storage medium 316 may be an internal hard disk or DVD, or an auxiliary storage device such as an external hard disk or DVD.

The display section 318 displays a virtual space that can be shared with another user based on at least the virtual space creation data from the virtual space provision server 100.

The control section 317 controls the operation of each section based on the predetermined control program stored in the ROM (not shown). For example, based on the virtual space creation program downloaded and installed from the virtual space provision server 100, the control section 317 also implements a Web server access module 317a, a Web address information acquisition module 317b, a Web page viewing module 317c, a transmission module 317d, a virtual space information reception module 317e, a virtual space display control module 317f, an avatar management module 317g, an item management module 317h, a change-related data transmission module 317i, an avatar change data detection module 317j, an item change data detection module 317k, a virtual space edit module 317l, and a centralized control module 317A.

In turn, the Web server access module 317a, the Web address information acquisition module 317b, the Web page viewing module 317c, the transmission module 317d, the virtual space information reception module 317e, the virtual space display control module 317f, the avatar management module 317g, the item management module 317h, the change-related data transmission module 317i, the avatar change data detection module 317j, the item change data detection module 317k, the virtual space edit module 317l, the centralized control module 317A perform the following operations.

The Web server access module 317a serving as the Web server access means connects to any one of the Web servers 210 to 230 via a network or the Internet 400.

The Web address information acquisition module 317b serving as the Web address information acquisition means acquires the Web address information of anyone of the Web servers 210 to 230 accessed by the Web server access module 317a.

The Web page viewing module 317c serving as the Web page viewing means acquires the Web page information from the Web address acquired by the Web address information acquisition module 317b and then displays the Web page on the display section 318 serving as the display means.

The transmission module 317d serving as the transmission means has, for example, a virtual space icon having the Web address information of the virtual space provision server 100. When the virtual space icon is clicked (or selected), the module 317d sends, to the virtual space provision server 100, the aforementioned Web address information of any one of the user terminals 310 to 330 that has clicked (or selected) the virtual space icon and the virtual space user information.

Here, the virtual space icon is displayed on the screen of the user terminals 310 to 330 by installing the virtual space creation program downloaded in advance from the virtual space provision server 100, and has the Web address information for access to the virtual space provision server 100. Accordingly, the virtual space icon has to be only clicked (or selected) without entering the Web address of the virtual space provision server 100 in order to enter the Web address of the virtual space provision server 100 and access the virtual space provision server 100.

Furthermore, upon sending at least the Web address information to the virtual space provision server 100, the transmission module 317d converts the Web address information into fixed-length data, for example, a hash value so as to transmit it to the virtual space provision server 100. Such hash values, which are used for the so-called encryption, vary in length depending on the algorithm, but are characterized by being fixed in length regardless of the size of original data (such as text data or image data).

In this regard, the hash value has a constant length of about 128 to 512 bits regardless of the size of original data. Furthermore, such a technique for obtaining a hash value through the hash function is characterized in that the original data cannot be identified even when the hash value and the hash function are known.

Furthermore, the same hash value is created for the same pieces of original data, while different hash values are created for different pieces of original data. Therefore, upon a log-in from the user terminals 310 to 330, i.e., when the aforementioned virtual space icon is clicked for entry of the user ID and password for log-in, the hash value is produced accordingly. That is, the same hash value is produced for the same pieces of Web address information acquired by the Web address information acquisition module 317b, whereas different hash values are produced for different pieces of Web address information.

Note that it is assumed here that hash values are produced based on the Web address information as the original data. However, without being limited to this embodiment, another encryption technique may also be employed to produce fixed-length data.

On the other hand, the aforementioned virtual space icon may also be displayed separately on the screen of the user terminals 310 to 330 or incorporated into a predetermined tool bar. Alternatively, the icon may be incorporated into a dedicated browser or added on to an existing browser.

The virtual space of information reception module 317e serving as the virtual space information reception means receives virtual space information based on the Web address information from the virtual space provision server 100.

In accordance with the virtual space information received by the virtual space information reception module 317e, the virtual space display control module 317f serving as the virtual space display control means allows the virtual space image based on the Web address information and the avatar image of the user accessing the Web address to be created and displayed on the display section 318 serving as the display means.

Note that upon producing a virtual space image and the avatar image of a user accessing a Web address, the virtual space display control module 317f uses various types of elements contained in the already installed virtual space creation program to create a virtual space to be displayed on the display section 318 of any one of the user terminals 310 to 330.

Furthermore, an avatar image tied to the user attending at the user terminal 310 may be moved around the virtual space by manipulating the mouse or keyboard. In this case, the virtual space display control module 317f produces the virtual space so that the position of the avatar image changes in accordance with the manipulation.

Furthermore, an item image such as houses selected from among the various types of elements contained in the already installed virtual space creation program is placed in the virtual space by manipulating the mouse or keyboard. In this case, the virtual space display control module 317f produces the virtual space so as to display the item image such as houses in accordance with the manipulation.

The avatar management module 317g serving as the avatar management means manages the avatar image selected from among the various types of elements contained in the already installed virtual space creation program by tying the avatar image to the user attending at the user terminal 310. Furthermore, when an avatar image is moved within the virtual space by manipulating the mouse or keyboard, the avatar management module 317g is to control the position of the avatar image before and after its movement, for example, using the coordinates.

An item image such as houses may be selected by manipulating the mouse or keyboard from among the various types of elements contained in the virtual space creation program already installed. In this case, the item management module 317h serving as the item management means manages the item image by tying the image to the user attending at the user terminal 310. When an item image such as houses is being deleted by manipulating the mouse or keyboard, the item management module 317h eliminates the tie between the item image and the user.

The change-related data transmission module 317i serving as the first data transmission means and the second data transmission means sends change-related data. The change-related data includes avatar change data involved in a movement of an avatar image managed by the avatar management module 317g and item change data involved in setting up an item such as houses or item setup cancellations managed by the item management module 317h. Note that the change-related data transmission module 317i is configured to send the change-related data such as avatar change data or item change data immediately after a change occurs in the contents managed by the avatar management module 317g or the item management module 317h.

The avatar change data detection module 317j serving as the avatar change data detection means detects avatar change data involved in a movement of the avatar image on another one of the user terminals 320 and 330 from the virtual space creation data tied to a change on the another one of the user terminals 320 and 330 provided by the virtual space provision server 100.

The item change data detection module 317k serving as the item change data detection means detects item change data relating to setting up items such as houses or item setup cancellations on another one of the user terminals 320 and 330 from the virtual space creation data tied to a change on the another one of the user terminals 320 and 330 provided by the virtual space provision server 100.

When the avatar change data has been detected by the avatar change data detection module 317j, the virtual space edit module 317l serving as the first virtual space edit means and second virtual space edit means performs edit processing to change the position of the avatar image tied to the user attending at another one of the user terminals 320 and 330 within the virtual space of the user terminal 310.

Furthermore, when the item change data has been detected by the item change data detection module 317k, the virtual space edit module 317l performs edit processing for the setup (display) or setup cancellation (display cancellation) of the item image such as houses tied to the user attending at another one of the user terminals 320 and 330 within the virtual space of the user terminal 310.

The centralized control module 317A collectively manages processing in the Web server access module 317a, the Web address information acquisition module 317b, the Web page viewing module 317c, the transmission module 317d, the virtual space information reception module 317e, the virtual space display control module 317f, the avatar management module 317g, the item management module 317h, the change-related data transmission module 317i, the avatar change data detection module 317j, the item change data detection module 317k, and the virtual space edit module 317l.

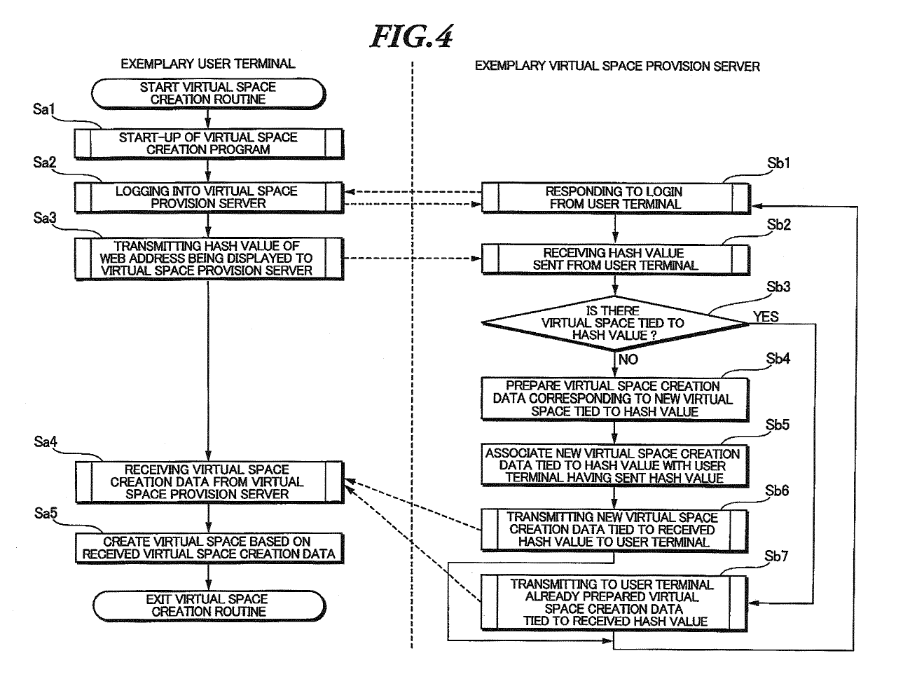

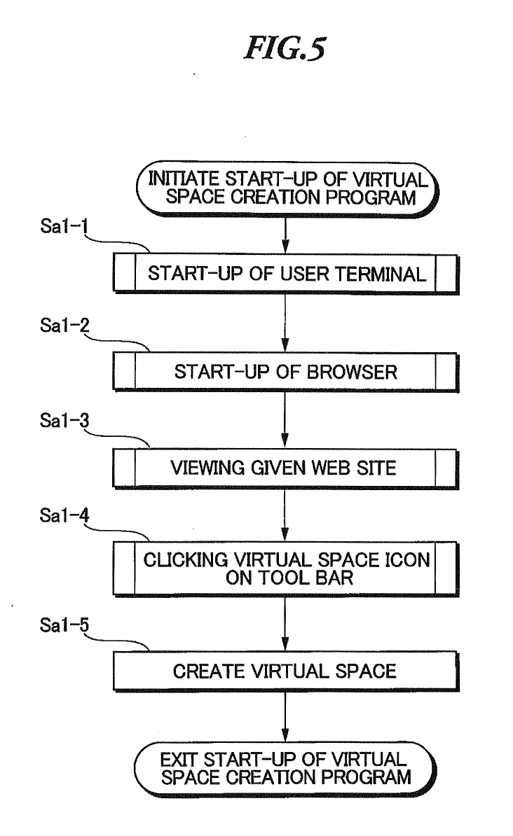

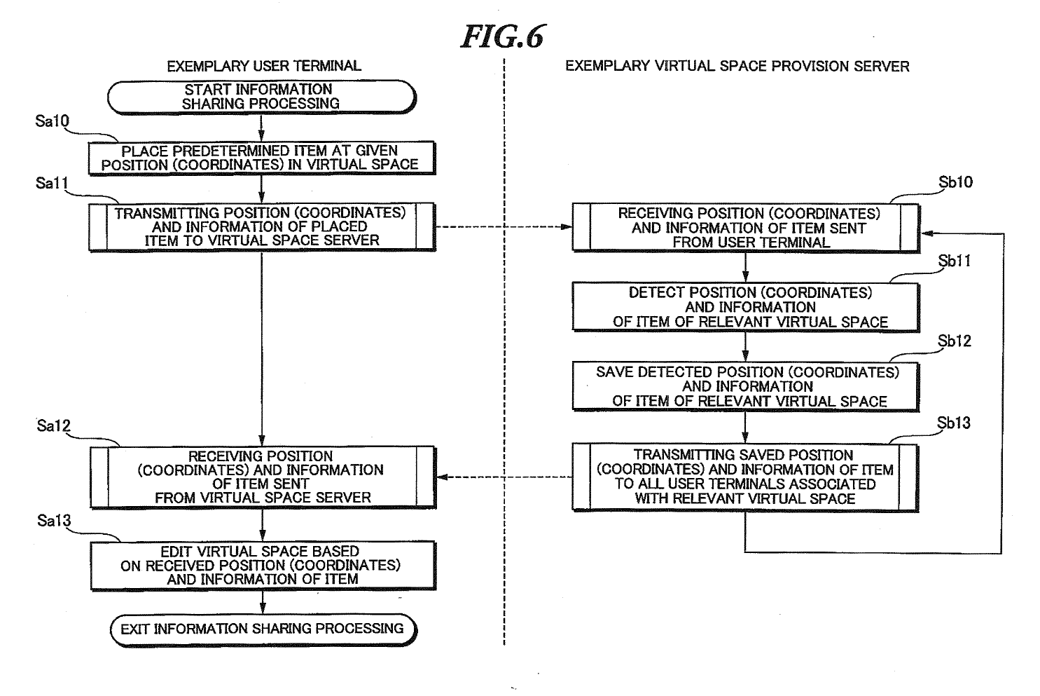

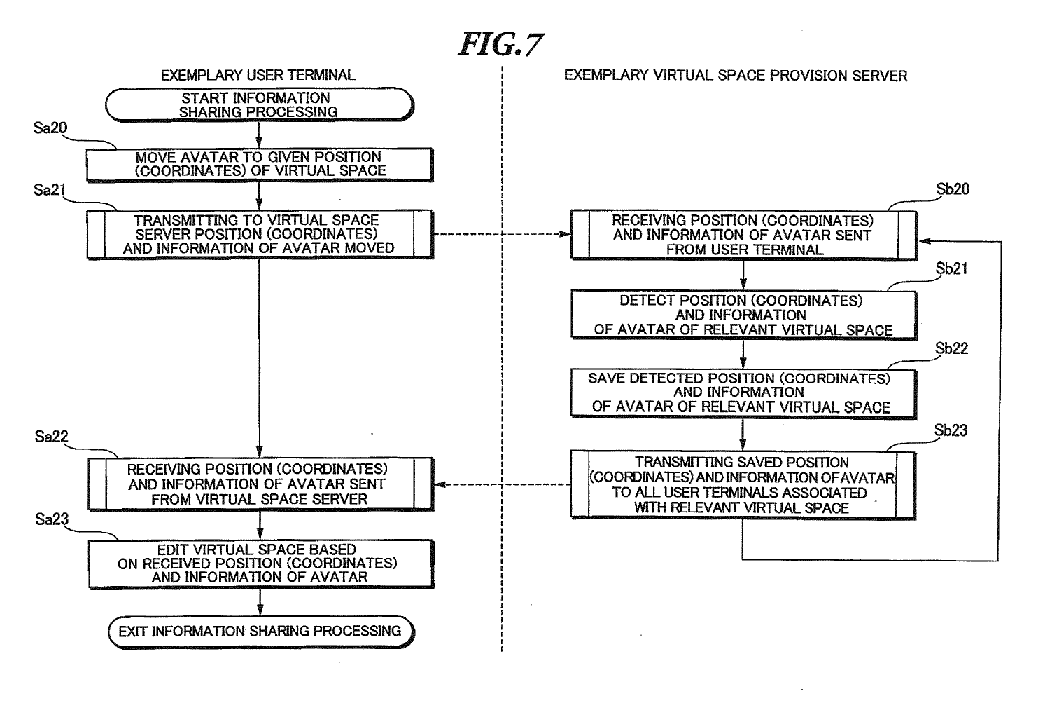

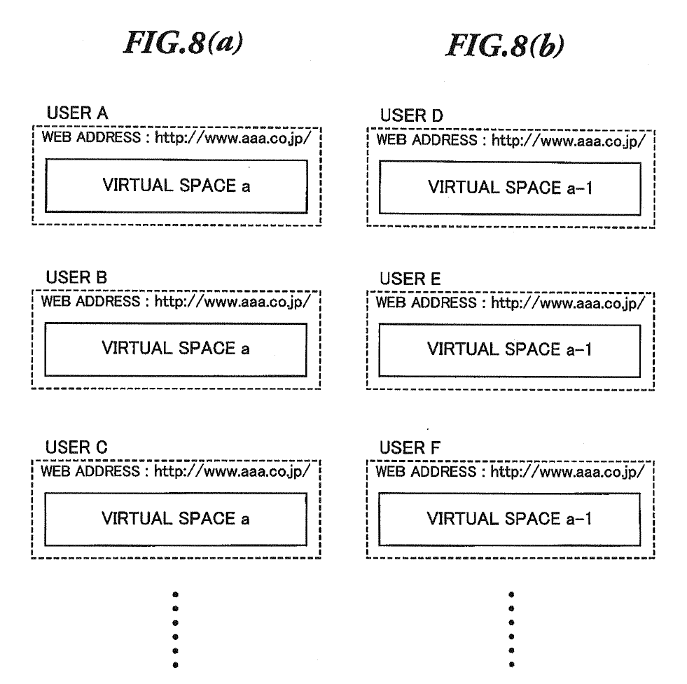

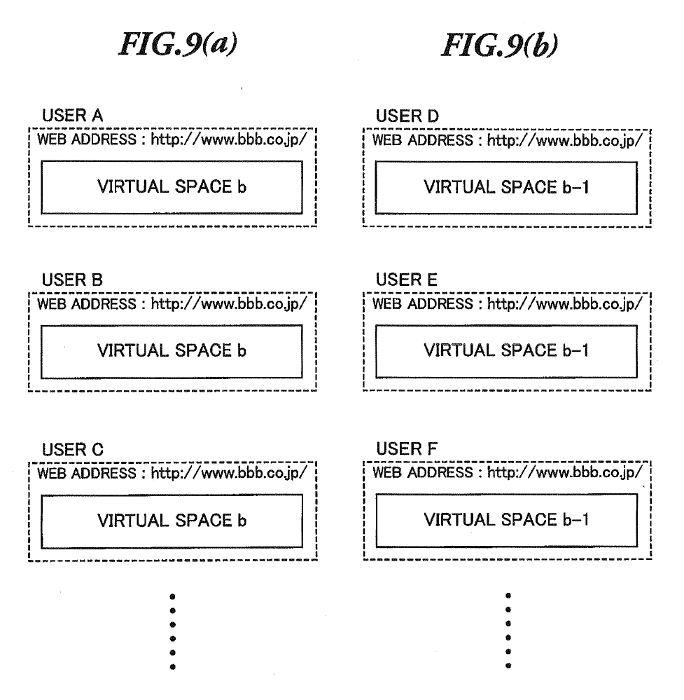

Now, with reference to FIGS. 4 to 9, a description will be made to a virtual space provision method in a virtual space provision system. Here, FIG. 4 is an explanatory flowchart for a virtual space creation routine. FIG. 5 is an explanatory flowchart for start-up processing of the virtual space creation program of FIG. 4. FIGS. 6 and 7 are an explanatory flowchart showing how to share a virtual space. FIGS. 8 and 9 are an explanatory view showing how to share a virtual space.

Note that in the descriptions below, it is assumed that each user attending at each of the user terminals 310 to 330 has registered the user information containing at least the user ID and password with the virtual space provision server 100. It is also assumed that the virtual space creation program provided by the virtual space provision server 100 has been already installed in each of the user terminals 310 to 330. It is further assumed that on the screen of each of the user terminals 310 to 330, the virtual space icon for access to the virtual space provision server 100 has been added, for example, onto the tool bar of the existing browser through the virtual space creation program having been installed therein.

Then, first, as shown in FIG. 4, to start the virtual space creation routine, the start-up processing of the virtual space creation program is executed (step Sa1). As shown in FIG. 5, in the start-up processing of the virtual space creation program, the user terminals 310 to 330 are first started (step Sa1-1), the aforementioned browser downloaded and installed for display is then started (step Sa1-2), and the given Web page is viewed via the browser (step Sa1-3).

Here, when the virtual space icon having been added onto the tool bar of the browser for viewing the given Web page is clicked (step Sa1-4), the process proceeds to create a virtual space (step Sa1-5).

As shown in FIG. 4, in creating the virtual space, the virtual space provision server 100 is logged in (step Sa2). At this stage, for example, if the virtual space icon is clicked on the user terminal 310, a log-in window is displayed on the display section 318 of the user terminal 310 to urge the entry of the user ID and the password.

Here, after the user ID and the password have been entered on the log-in window, for example, a button indicative of “OK” or completion is clicked. Then, the virtual space provision server 100 is logged in, so that the virtual space provision server 100 responses the log-in given by the user terminal 310 (step Sb1).

Furthermore, almost at the same time as the user terminal 310 has logged in the virtual space provision server 100, the hash value according to the Web address information of the predetermined Web page being viewed on the user terminal 310 is sent to the virtual space provision server 100 (step Sa3).

Upon receiving the hash value from the user terminal 310 (step Sb2), the virtual space provision server 100 determines whether there is a virtual space tied to that hash value (step Sb3). Here, in the initial status, there is no virtual space tied to any hash value. Thus, if no virtual space is tied to any hash value (step Sb3: NO), a new virtual space tied to that hash value is created.

In this case, for example, the virtual space creation data for creating a new virtual space tied to the hash value from the user terminal 310, that is, the virtual space creation data for creating a virtual space separate from the already created virtual space is newly created (step Sb4). The new virtual space creation data tied to the hash value is associated with the user terminal 310 having transmitted the hash value (step Sb5).

After such an association, the additional virtual space creation data tied to the hash value is sent to the user terminal 310 (step Sb6). In contrast to this, if a virtual space tied to a hash value is already available, it is determined whether an allocation can be made to that already existing virtual space.

That is, in allocating a virtual space displayed on the user terminals 310 to 330 according to the hash value detected at the aforementioned hash value detection module 113, in principle, the virtual space of the same contents is produced on each of the user terminals 310 to 330 if the same hash value has been provided by the user terminals 310 to 330.

As such, for example, when users respond to the same Web address information while viewing a game-related Web page, the users viewing the game-related Web page share the same virtual space with one another. Furthermore, for example, when users respond to the same Web address information while viewing a travel-related Web page, the users viewing the travel-related Web page share the same virtual space with one another.

However, as described above, an excessive number of users concentrated in one virtual space would increase the number of the avatar images (graphical images representing the users) in the virtual space of each of the user terminals 310 to 330. This would make the management of the session by the aforementioned user management module 111 complicated as well as responses from the virtual space provision server 100 delayed. This may thus cause inconveniences such as delay in the progression of communication games.

In this context, when the hash values from the user terminals 310 to 330 are the same, the virtual space information creation module 114 allocates virtual spaces so that one virtual space can accommodate, for example, 500 avatar images (graphical images representing the users).

Here, for example, suppose that in step Sb3, a virtual space tied to the hash value from the user terminal 310 has already been created, and the number of avatar images (graphical images representing the users) that can be accommodated in that virtual space is limited, for example, to 500. In this case, for example, if the number of the avatar images (graphical images representing the users) in the virtual space is less than 500, then a virtual space tied to the hash value from the user terminal 310 can be allocated to the virtual space that has already been created.

In this case, for example, the virtual space creation data for creating the virtual space tied to the hash value from the user terminal 310, that is, the virtual space creation data for producing the virtual space that has already been created is sent to the user terminal 310 (step Sb7).

For example, the virtual space creation data for producing the virtual space that has already been created is sent to the user terminal 310 in the procedures described above. As shown in FIG. 8(a), the procedures may be followed by users A to C clicking the virtual space icon and logging into the virtual space provision server 100 to view their respective predetermined Web pages each with the Web address information, for example, “http://www.aaa.co.jp/”. In this case, based on the virtual space creation data according to the hash value of the “http://www.aaa.co.jp/”, the users A to C are thus allowed to share the same virtual space “a.”

However, as described above, an excessive number of users concentrated in one virtual space would make the management of the session by the user management module 111 complicated. This would also cause inconveniences such as delay in response from the virtual space provision server 100, resulting in the progression of communication games being delayed. Thus, the aforementioned virtual space information creation module 114 makes allocations as described above.

In this case, as shown in FIG. 8(b), the procedures may be followed by users D to F clicking the virtual space icon and logging into the virtual space provision server 100 to view their respective predetermined Web pages each with the Web address information “http://www.aaa.co.jp/” in the same manner as above. Even in this case, the virtual space creation data according to the hash value of the “http://www.aaa.co.jp/” may be made differently from the virtual space creation data of FIG. 8(a), thereby allowing the users D to F to share the same virtual space “a-1.”

Likewise, for example, as shown in FIG. 9(a), the users A to C may click the virtual space icon and log in the virtual space provision server 100 to view their respective predetermined Web pages with the Web address information, for example, “http://www.bbb.co.jp/”. In this case, based on the virtual space creation data according to the hash value of the “http://www.bbb.co.jp/”, the users A to C are allowed to share the same virtual space “b.”

On the other hand, the aforementioned virtual space information creation module 114 may make allocations because an excessive number of users have concentrated in one virtual space. In this case, as shown in FIG. 9(b), the users D to F may click the virtual space icon and log in the virtual space provision server 100 to view their respective predetermined Web pages each with the Web address information “http://www.bbb.co.jp/” in the same manner as above. Even in this case, the virtual space creation data according to the hash value of the “http://www.bbb.co.jp/” may be made different from the virtual space creation data of FIG. 9(a), thereby allowing the users D to F to share the same virtual space “b-1.”

Note that the virtual space created by following the procedures described above is not always saved in a database 110a of the virtual space provision server 100 but deleted when the number of avatar images in the virtual space has become zero. This allows for reducing the load of the virtual space provision server 100.

Now, a description will be made as to how to share a virtual space with another user. First, as shown in FIG. 6, for example, on the user terminal 310, a predetermined item image is set up at a predetermined position (coordinates) in a virtual space. That is, an item image such as a house is selected from various types of elements contained in an already installed virtual space creation program to drag & drop it at a predetermined position in the virtual space (step Said). Then, the position (coordinates) of the placed item image and the information of the item image are sent to the virtual space provision server 100 (step Sall). Here, the information of an item image refers, for example, to a code number associated with various types of elements contained in the virtual space creation program.

The virtual space provision server 100 receives the position (coordinates) of the item image and the information of the item image from the user terminal 310 (step Sb10). Then, the server 100 detects the position (coordinates) of the item image and the information of the item image of the relevant virtual space (step Sb11).

Subsequently, the position (coordinates) of the item image and the information of the item image of the relevant virtual space, thus detected, are saved (step Sb12). The position (coordinates) of the item image and the information of the item image saved in all the user terminals or the user terminals 320 and 330 associated with the relevant virtual space are transmitted (step Sb13).

Here, the user terminals 320 and 330 receive the position (coordinates) of the item image and the information of the item image sent from the virtual space provision server 100 (step Sa12). Then, the terminals 320 and 330 edit a virtual space based on the position (coordinates) of the item image and the information of the item image thus received (step Sa13).

For example, when the user terminal 310 has set up a predetermined item image at a predetermined position (coordinates) in the virtual space, the other user terminals 320 and 330 have the same virtual space contents as those of the user terminal 310, allowing the virtual space to be shared.

Note that for example, the user terminal 310 selects an item image such as a house from the various types of elements contained in the virtual space creation program to drag & drop it at a predetermined position in a virtual space. The virtual space provision server 100 saves in the database 110a the virtual space with the item image having been set up this way. However, the virtual space may be deleted from the database 110a when the item image is deleted.

Here, a description has been made as to how to share a virtual space when a predetermined item image is set up at a predetermined position (coordinates) in a virtual space, for example, on the user terminal 310. However, for example, even when an avatar image has been moved in the virtual space of the user terminal 310, another one of the user terminals 320 and 330 has the same virtual space contents as those of the user terminal 310, thereby allowing the virtual space to be shared.

That is, as shown in FIG. 7, for example, on the user terminal 310, suppose that an avatar image having been already placed in the virtual space is moved to a predetermined position (coordinates) (step Sa20). Then, the position (coordinates) of the moved avatar image and the information of the avatar image are sent to the virtual space provision server 100 (step Sa21). Here, the information of the avatar image refers, for example, to a code number associated with various types of elements contained in the virtual space creation program.

The virtual space provision server 100 receives the position (coordinates) of the avatar image and the information of the avatar image from the user terminal 310 (step Sb20). Then, the server 100 detects the position (coordinates) of the avatar image and the information of the avatar image of the relevant virtual space (step Sb21).

Subsequently, the position (coordinates) of the avatar image and the information of the avatar image of the detected relevant virtual space is saved (step Sb22). Then, the position (coordinates) of the avatar image and the information of the avatar image saved in all the user terminals or the user terminals 320 and 330 associated with the relevant virtual space are transmitted (step Sb23).

Here, the user terminals 320 and 330 receive the position (coordinates) of the avatar image and the information of the avatar image sent from the virtual space provision server 100 (step Sa22). Then, the terminals 320 and 330 edit a virtual space based on the position (coordinates) of the avatar image and the information of the avatar image thus received (step Sa23).

For example, when the avatar image is moved to the predetermined position (coordinates) in the virtual space on the user terminal 310, another one of the user terminals 320 and 330 has the same virtual space contents as those of the user terminal 310, thereby allowing the virtual space to be shared.

As such, according to the present example, the user terminals 310 to 330 acquire the Web address information of a Web page being viewed thereon and send it to the virtual space provision server 100. Based on the virtual space information according to the Web address information from the virtual space provision server 100, the user terminals produce a virtual space. Furthermore, for example, any change in the avatar image or the item image in the virtual space of any one of the user terminals 310 to 330 is reflected on the virtual space of another one of the user terminals 310 to 330. This allows those users viewing the same Web page to share the virtual space of the same contents with one another.

On the other hand, the virtual space provision server 100 manages user information containing, for example, at least the user IDs and the passwords to be used for access from a plurality of user terminals 310 to 330. The server 100 provides, for example, the virtual space creation program for implementing a virtual space to any one of the user terminals 310 to 330 that has registered the user information therewith. When having detected the Web address information sent from any one of the user terminals 310 to 330, the server 100 produces the virtual space creation data for creating a virtual space according to the detected Web address information and sends it to those user terminals 310 to 330 that have transmitted the Web address information.

As discussed above, for example, on the user terminals 310 to 330, the virtual space icon for accessing the virtual space provision server 100 may be clicked while a Web page is being viewed thereon. In this case, for example, a hash value according to the Web address information of the Web page being viewed is sent to the virtual space provision server 100. Then, for example, based on the virtual space creation data according to the hash value from the virtual space provision server 100, a virtual space is produced. This allows those users who are viewing the same Web page to share the virtual space of the same contents with one another. This means that such a virtual space has been provided which allows those users interested in any one of various Web pages to meet one another in real time through the Web page that interests them.

Furthermore, according to the present embodiment, the virtual space provision server 100 allocates a virtual space in accordance with the hash value sent from the user terminals 310 to 330. As described above, this allows those users viewing the same Web page to share the virtual space of the same contents with one another as well as the number of users sharing one virtual space to be restricted. This will thus not make the management of the session by the aforementioned user management module 111 complicated, so that the virtual space provision server 100 can provide a quick response and thus smoothly advance the progression of communication games.

Note that a modification can be made to the present embodiment which has been mainly described above. That is, in the present embodiment, users may click a virtual space icon and log into the virtual space provision server 100 to view their respective predetermined Web pages with the same Web address information. In this case, each user shares the same virtual space based on the virtual space creation data according to the hash value of the Web address information. It is also possible for the users to link a self-introduction page or a diary page with the avatar images (graphical images representing the users) present within the same virtual space, so that another avatar image in the same virtual space can be clicked to view the self-introduction page or the diary page of another user.

It is also possible to drag and drop an image, posted on a predetermined Web page, in the virtual space, thereby using the image as a texture image.

It is also possible to associate text characters, images, or moving images, posted on a predetermined Web page, with a virtual space (by screen capture or video capture), thereby extending the contents of the virtual space.

Furthermore, the present embodiment has been described above for the case where each of the user terminals 310 to 330 downloads the virtual space creation program from the virtual space provision server 100 to display a shared virtual space on each of the user terminals 310 to 330. However, for example, the virtual space creation program may also be recorded on a storage medium such as CDs to be distributed to each user.

### INDUSTRIAL APPLICABILITY

The present invention is applicable not only to communication games but also to online games.

1. A virtual space provision system, comprising a plurality of user terminals and a virtual space provision server connected to each other via a network,
said user terminal comprising:
Web server access means for connecting to a Web server via said network;
Web address information acquisition means for acquiring Web address information from the accessed Web server;
Web page viewing means for acquiring Web page information from the acquired Web address for displaying on display means;
transmission means for sending said Web address information and virtual space user information stored in storage means of said terminal to said virtual space provision server;
virtual space information reception means for receiving virtual space information based on said Web address information from said virtual space provision server; and
virtual space display control means for allowing a virtual space image based on said Web address information and an avatar image of a user accessing said Web address to be created in accordance with said received virtual space information and displayed on the display means, and
said virtual space provision server comprising:
Web address information reception means for receiving Web address information acquired by a first user terminal and a first piece of the virtual space user information from said first user terminal;
virtual space information creation means for creating virtual space information based on the received Web address information, said first piece of the virtual space user information, and a second piece of said virtual space user information from a second user terminal accessing said Web address; and
virtual space information transmission means for sending the created virtual space information to a group of said first user terminal and said second user terminal.

2. The virtual space provision system according to claim 1, wherein:
said virtual space provision server has program provision means for providing a virtual space creation program to display said virtual space in response to a request from said user terminal; and
said virtual space information creation means transmits virtual space creation data for allowing said virtual space creation program to display a virtual space.

3. The virtual space provision system according to claim 2, wherein:
said plurality of user terminals has
first data transmission means for sending avatar change data involved in a movement of an avatar image selected from among various types of elements contained in said virtual space creation program to said virtual space provision server,
avatar change data detection means for detecting avatar change data involved in a movement of an avatar image on another one of said user terminals from virtual space creation data provided by said virtual space provision server and tied to a change on the another one of said user terminals, and
first virtual space edit means for performing edit processing to provide the same contents as those of the virtual space on said another one of the user terminals when said avatar change data is detected; and
said virtual space provision server has
avatar change data detection means for detecting said avatar change data sent from any one of said user terminals, and
avatar change data transmission means for sending the virtual space creation data indicative of said avatar change data to another one of said user terminals when said avatar change data detection means detects said avatar change data.

4. The virtual space provision system according to claim 2 or 3, wherein:
said plurality of user terminals has
second data transmission means for sending item change data involved in selecting or deleting a predetermined item image selected from among various types of elements contained in said virtual space creation program to said virtual space provision server,
item change data detection means for detecting item change data involved in selecting or deleting an item image on another one of said user terminals from virtual space creation data provided by said virtual space provision server and tied to a change on the another one of said user terminals, and
second virtual space edit means for performing edit processing to provide the same contents as those of the virtual space on the another one of said user terminals when said item change data detection means detects said item change data; and
said virtual space provision server has
item change data detection means for detecting said item change data sent from any one of said user terminals, and
item change data transmission means for sending virtual space creation data indicative of said item change data to another one of said user terminals when said item change data detection means detects said item change data.

5. The virtual space provision system according to claim 2 or 3, wherein:
said virtual space provision server has virtual space allocation means for allocating a virtual space in accordance with the Web address information detected by said Web address information detection means; and
when the same Web address information is sent from each of said user terminals, said virtual space allocation means makes an allocation to each of said user terminals so that a virtual space of the same contents is produced thereon, whereas when different pieces of said Web address information are sent from each of said user terminals, said virtual space allocation means makes an allocation to each of said user terminals so that a virtual space is produced thereon according to respective pieces of said Web address information.

6. The virtual space provision system according to claim 2 or 3, wherein said virtual space provision server has virtual space management means for at least saving a virtual space caused by said virtual space creation data being transmitted, and for deleting said saved virtual space when at least the number of said avatar images in said saved virtual space becomes zero.

7. The virtual space provision system according to claim 2 or 3, wherein:
said plurality of user terminals have hash value creation means for creating a fixed-length hash value based on said acquired Web address information; and
said virtual space provision server creates virtual space creation data for creating a virtual space according to said hash value and transmits the data to said user terminal having sent said hash value.

8. The virtual space provision system according to claim 2 or 3, wherein said Web server access means has Web address information of said virtual space provision server and includes a virtual space icon, either separately or added on to some browser.

9. A virtual space provision server comprising:
Web address information reception means for receiving Web address information acquired by a first user terminal and a first piece of said virtual space user information from said first user terminal;
virtual space information creation means for creating virtual space information based on the received Web address information, said first piece of the virtual space user information, and a second piece of said virtual space user information from a second user terminal accessing said Web address; and
virtual space information transmission means for sending the created virtual space information to a group of said first user terminal and said second user terminal.

10. The virtual space provision server according to claim 9, comprising program provision means for providing a virtual space creation program to display said virtual space in response to a request from any of said user terminals,
wherein said virtual space information creation means transmits virtual space creation data for displaying the virtual space by virtue of said virtual space creation program.

11. The virtual space provision server according to claim 10, comprising:
avatar change data detection means for detecting said avatar change data sent from any one of said user terminals; and
avatar change data transmission means for sending virtual space creation data indicative of said avatar change data to another one of said user terminals when said avatar change data detection means detects said avatar change data.

12. The virtual space provision server according to claim 10 or 11, comprising:
item change data detection means for detecting said item change data sent from any one of said user terminals; and
item change data transmission means for sending virtual space creation data indicative of said item change data to another one of said user terminals when said item change data detection means detects said item change data.

13. The virtual space provision server according to claim 10 or 11, comprising virtual space allocation means for allocating the virtual space in accordance with the Web address information detected by said Web address information detection means, and
wherein, when the same Web address information is sent from each of said user terminals, said virtual space allocation means makes an allocation to each of said user terminals so that a virtual space of the same contents is produced thereon, whereas when different pieces of said Web address information are sent from each of said user terminals, said virtual space allocation means makes an allocation to each of said user terminals so that a virtual space is produced thereon according to respective pieces of said Web address information.

14. The virtual space provision server according to claim 10 or 11, comprising virtual space management means for at least saving the virtual space caused by said virtual space creation data being transmitted, and for deleting said saved virtual space when at least the number of said avatar images in the virtual space becomes zero.

15. The virtual space provision server according to claim 10 or 11, wherein virtual space creation data for creating a virtual space according to a fixed-length hash value based on the Web address information acquired on said user terminal is created and then sent to said user terminal having transmitted said hash value.

16. A virtual space provision method which, when a plurality of user terminals share a virtual space via a network and a virtual space provision server connected to said network displays said virtual space on the plurality of said user terminals, allows the plurality of user terminals to follow the steps of:
connecting to a Web server via said network;
acquiring Web address information of the accessed Web server;
acquiring Web page information from the acquired Web address and displaying the same on display means;
sending said Web address information and virtual space user information stored in storage means of said terminal to said virtual space provision server;
receiving virtual space information based on said Web address information from said virtual space provision server; and
creating a virtual space image based on said Web address information and an avatar image of a user accessing said Web address in accordance with said received virtual space information and displaying the same on the display means, and
said method also allows said virtual space provision server to follow the steps of:
receiving Web address information acquired by a first user terminal and a first piece of said virtual space user information from said first user terminal;
creating virtual space information based on the received Web address information, said first piece of the virtual space user information, and a second piece of said virtual space user information from a second user terminal accessing said Web address; and
sending the created virtual space information to a group of said first user terminal and said second user terminal.

17. The virtual space provision method according to claim 16, wherein said virtual space provision server follows a step of providing a virtual space creation program for displaying said virtual space in response to a request from said user terminal, and after said virtual space creation program is provided, transmits virtual space creation data for displaying the virtual space by virtue of said virtual space creation program.

18. The virtual space provision method according to claim 17, allowing said plurality of user terminals to follow the steps of:
sending avatar change data involved in a movement of an avatar image selected from among various types of elements contained in said virtual space creation program to said virtual space provision server;
detecting avatar change data involved in a movement of an avatar image on another one of said user terminals, from virtual space creation data tied to a change on the another one of said user terminals provided by said virtual space provision server; and
performing edit processing to provide the same contents as those of the virtual space on the another one of said user terminals when said avatar change data is detected; and
the method also allowing said virtual space provision server to follow the steps of:
detecting said avatar change data sent from any one of said user terminals; and
sending the virtual space creation data indicative of said avatar change data to another one of said user terminals when said avatar change data is detected.

19. The virtual space provision method according to claim 17 or 18, allowing said plurality of user terminals to follow the steps of:
sending item change data involved in selecting or deleting a predetermined item image selected from among various types of elements contained in said virtual space creation program to said virtual space provision server;
detecting item change data involved in selecting or deleting an item image on another one of said user terminals from virtual space creation data provided by said virtual space provision server and tied to a change on the another one of said user terminals; and
performing edit processing to provide the same contents as those of the virtual space on the another one of said user terminals when said item change data is detected; and
the method also allowing said virtual space provision server to follow the steps of:
detecting said item change data sent from any one of said user terminals; and
sending virtual space creation data indicative of said item change data to another one of said user terminals when said item change data is detected.

20. The virtual space provision method according to claim 17 or 18, allowing said virtual space provision server to follow the step of allocating the virtual space in accordance with the Web address information detected by said Web address information detection means; and
wherein when the same Web address information is sent from each of said user terminals, an allocation is made to each of said user terminals so that a virtual space of the same contents is produced thereon, whereas when different pieces of said Web address information are sent from said respective user terminals, an allocation is made to each of said user terminals so that a virtual space is produced thereon according to respective pieces of said Web address information.

21. The virtual space provision method according to claim 17 or 18, allowing said virtual space provision server to follow the step of at least saving a virtual space caused by said virtual space creation data being transmitted, and deleting said saved virtual space when at least the number of said avatar images in said virtual space becomes zero.

22. The virtual space provision method according to claim 17 or 18, allowing said plurality of user terminals to follow the step of creating a fixed-length hash value based on said acquired Web address information, and
wherein said virtual space provision server creates virtual space creation data for creating a virtual space according to said hash value and transmits the data to said user terminal having sent said hash value.

23. A virtual space provision program implemented by a computer, which, when a plurality of user terminals share a virtual space via a network and a virtual space provision server connected to said network displays said virtual space on the plurality of said user terminals, allows the plurality of user terminals to follow the steps of:
connecting to a Web server via said network;
acquiring Web address information of the accessed Web server;
acquiring Web page information from the acquired Web address and displays the same on display means;
sending said Web address information and virtual space user information stored in storage means of said terminal to said virtual space provision server;
receiving virtual space information based on said Web address information from said virtual space provision server; and
creating a virtual space image based on said Web address information and an avatar image of a user accessing said Web address in accordance with said received virtual space information and display the same on the display means, and
the program also allows said virtual space provision server to follow the steps of:
receiving Web address information acquired by a first user terminal and a first piece of said virtual space user information from said first user terminal;
creating virtual space information based on the received Web address information, said first piece of the virtual space user information, and a second piece of said virtual space user information from a second user terminal accessing said Web address; and
sending the created virtual space information to a group of said first user terminal and said second user terminal.

24. The virtual space provision program according to claim 23, allowing said virtual space provision server to follow a step of providing a virtual space creation program to display said virtual space in response to a request from said user terminal, and
wherein after said virtual space creation program is provided, said virtual space provision server transmits virtual space creation data for displaying the virtual space by virtue of said virtual space creation program.

25. The virtual space provision program according to claim 24, allowing said plurality of user terminals to follow the steps of:
sending avatar change data involved in a movement of an avatar image selected from among various types of elements contained in said virtual space creation program to said virtual space provision server;
detecting avatar change data involved in a movement of an avatar image on another one of said user terminals from virtual space creation data provided by said virtual space provision server and tied to a change on the another one of said user terminals; and
performing edit processing to provide the same contents as those of the virtual space on the another one of said user terminals when said avatar change data is detected; and
said program also allowing the virtual space provision server to follow the steps of:
detecting said avatar change data sent from any one of said user terminals; and
sending the virtual space creation data indicative of said avatar change data to another one of said user terminals when said avatar change data is detected.

26. The virtual space provision program according to claim 24 or 25, allowing said plurality of user terminals to follow the steps of:
sending item change data involved in selecting or deleting a predetermined item image selected from among various types of elements contained in said virtual space creation program, to said virtual space provision server;
detecting item change data involved in selecting or deleting an item image on another one of said user terminals from virtual space creation data provided by said virtual space provision server and tied to a change on the another one of said user terminals; and
performing edit processing to provide the same contents as those of the virtual space on the another one of said user terminals when said item change data is detected; and
said program also allowing said virtual space provision server to follow the steps of:
detecting said item change data sent from any one of said user terminals; and
sending virtual space creation data indicative of said item change data to another one of said user terminals when said item change data is detected.

27. The virtual space provision program according to claim 24 or 25, allowing said virtual space provision server to follow the step of allocating the virtual space in accordance with the Web address information detected by said Web address information detection means, and
wherein when the same Web address information is sent from each of said user terminals, an allocation is made to each of said user terminals so that a virtual space of the same contents is produced thereon, whereas when different pieces of said Web address information are sent from said respective user terminals, an allocation is made to each of said user terminals so that a virtual space is produced thereon according to respective pieces of said Web address information.

28. The virtual space provision program according to claim 24 or 25, allowing said virtual space provision server to follow the step of at least saving a virtual space caused by said virtual space creation data being transmitted, and deleting said saved virtual space when at least the number of said avatar images in said virtual space becomes zero.

29. The virtual space provision program according to claim 24 or 25, allowing said plurality of user terminals to follow the step of creating a fixed-length hash value based on said acquired Web address information, and
wherein said virtual space provision server creates virtual space creation data for creating a virtual space according to said hash value and transmits the data to said user terminal having sent said hash value.
